(19) United States
(12) Patent Application Publication
(10) Pub. No.: US 2015/0167783 A1
(43) Pub. Date: Jun. 18, 2015

(54) DEVICE FOR CONNECTING FIRST AND SECOND ELONGATED MEMBERS

(71) Applicant: NATIONAL OILWELL VARCO NORWAY AS, Kristiansand S (NO)

(72) Inventor: Lars-Wichmann Jansen, Kristiansand (NO)

(21) Appl. No.: 14/407,297

(22) PCT Filed: Jun. 12, 2013
(86) PCT No.: PCT/NO2013/050105

§ 371 Date: Dec. 11, 2014

Related U.S. Application Data
(60) Provisional application No. 61/658,580, filed on Jun. 12, 2012.

(51) Int. Cl. F16G 11/09

(52) U.S. Cl. CPC F16G 11/09

(57) ABSTRACT

A connecting device for connecting first and second elongated members including a first connecting member configured to be connected to the first elongated member; a second connecting member configured to be connected to the second elongated member; and a link member for connecting the first and second connecting members together, wherein the connecting device is formed with a maximum diameter substantially equal to the diameter of the first and second elongated members.

### CROSS-REFERENCE TO RELATED APPLICATIONS

This application is a 35 U.S.C. §371 national stage application of PCT/NO2013/050105 filed Jun. 12, 2013 and entitled “Device for Connecting First and Second Elongated Members,” which claims priority to U.S. Provisional Application No. 61/658,580 filed Jun. 12, 2012 and entitled “Rope Link,” both of which are hereby incorporated herein by reference in their entirety for all purposes.

### STATEMENT REGARDING FEDERALLY SPONSORED RESEARCH OR DEVELOPMENT

Not applicable.

### BACKGROUND

The disclosure relates to a device for connecting first and second elongated members. More specifically the disclosure relates to a connecting device for connecting first and second elongated members, the connecting device comprising a first connecting member adapted to be connected to the first elongated member, a second connecting member adapted to be connected to the second elongated member, and a link member for connecting the first and second connecting members together.

Winches, drums, sheaves, capstans etc., are used for guiding, controlling, and/or storing ropes, wire ropes, cables, etc., hereinafter generalized by the term “elongated members”. Some drums are under-dimensioned with respect to the large forces/hoop stresses that may be acting on the drum from an inner layer of an elongated member due to heavy loads being suspended from the elongated member. The result may be that the drum is plastically deformed and thus destroyed. A solution could be to lay an inner layer of wire on the drum with a low tension, and tension up the wire from a second, above-lying layer over a number of safety turns. However, after having let out a full or nearly full length of elongated member with a heavy load at the end, the same load cannot be pulled in without exposing the drum to the full tension or near full tension of the load. This can be the case, for instance, when lowering equipment from a vessel and down to a seabed. The whole elongated member could be replaced by a new, longer elongated member, but elongated members for lifting heavy loads, such as 128 millimeter steel wires, are very expensive. The cost of a 3000 meter long 128 millimeter thick steel wire is well above $1.5 million. Known connecting devices for extending an existing elongated member by an additional length create an extended diameter portion of the extended elongated member. Further, the known connecting devices are not adapted to be bent so as to be properly stored on drums while properly supporting above-lying layers of an elongated member. Neither are the known link devices adapted to pass through sheaves and capstans of various diameters, thus hindering spooling of the extended elongated member onto a drum. Furthermore, in case of an emergency, for instance an offshore emergency where a vessel with a lifting crane has to be cut loose from a load suspended from an elongated member in the crane, the crane may be exposed to excessively large and damaging forces if the load cannot be freed from the crane in a controlled and safe manner.

### BRIEF SUMMARY OF THE DISCLOSURE

The disclosure has for its object to remedy or to reduce at least one of the disadvantages of the prior art, or at least to provide a useful alternative to the prior art.

The object is achieved by virtue of features disclosed in the following description and in the subsequent claims.

In a first aspect the disclosure relates to a connecting device for connecting first and second elongated members, the connecting device comprising: a first connecting member adapted to be connected to the first elongated member; a second connecting member adapted to be connected to the second elongated member; and a link member for connecting the first and second connecting members together, wherein the connecting device is formed with a maximum diameter substantially equal to the diameter of the first and second elongated members.

By forming the connecting device with a diameter substantially equal to that of the first and second elongated members, the connecting device may properly support overlying layers of elongated members. Further, the connecting device may pass through varying spooling apparatuses for letting out and pulling in the elongated members, where the spooling apparatuses may be adjusted to work with elongated members of a specific diameter. The first and second elongated members may be of a substantially equal diameter.

In one embodiment the connecting device may be adapted to be bent, at least in one plane containing a longitudinal axis of the connecting device. The bending may facilitate pulling the connected elongated members onto a drum and/or through a sheave or capstan. In a further embodiment the connecting device may be adapted to be bent in any plane containing the longitudinal axis thereof. The connected elongated members may thus be pulled onto a drum and/or through a sheave or capstan despite the connecting device being randomly twisted around its longitudinal axis.

A first part of an outer surface of the connecting device, when being bent, may form a substantially circular arc. The first part of the outer surface may be a surface of the connecting device adapted to abut a groove on a circular cylindrical drum on which the elongated members may be stored, and the curvature of the first part of the outer surface may be fitting complementary to that of the groove in the drum. The fit between the drum and the connecting device may thus be optimized. The curvature of the first part of the outer surface may be variable by bending the connecting device, which makes it possible to fit to drums and pass through sheaves or capstans of various diameters. The shape of the bent connecting device will be a result of both the relative position of the connecting members to the link member and to each other as well as the shape of the outer surface of the connecting members. The shape of the outer surface of the connecting members may be slightly curved so as to aid in the support of overlying layers and to improve the fit to a drum.

Further, a second part of the outer surface of the connecting device, when being bent, may also form a substantially circular arc. The second part of the outer surface may be part opposite the first part, and may thus be supporting an overlying layer of elongated member on a drum. The curvature of the second part of the outer surface of the connecting device may be fitting complementary to the inner curvature of an overlying layer of elongated member.

In one embodiment of the connecting device the link member may be connecting the first and second connecting members by means of first and second bolts through-going in first and second holes in the link member. The bolts may also be through-going in holes in the connecting members. The holes in the connecting members may be threaded. The bolt may be provided with threaded end parts with a larger diameter than a non-threaded mid part.

In a further embodiment the first and second holes of the link member may be provided with a first part formed with a first diameter, and a second part formed with a second diameter. This may be beneficial for allowing the bolt to pass through the hole in the link member while giving the bolt some radial clearance to be tilted in the hole while still obtaining a good fit between the link member and the bolt at a tensioned part of the bolt.

In one embodiment the link member of the connecting device may be formed with expanded width portions in a direction parallel to the center axes of the holes. The expanded width portions may be guiding the link member in its connection to the connecting members. Further, the expanded width portions may reduce the bending of the link member and reduce sliding of the link member relative to the bolt in the axial direction of the bolt.

In one embodiment the connecting device may be adapted to constitute a weak link when connecting the first and second elongated members. The weak link may be beneficial from a safety perspective, so as to avoid tension shocks to cranes, drums, sheaves, etc. The connecting device may be made with a lower minimum breaking load than the termination of the elongated member to the drum. Hence, in an emergency the elongated member can be pulled off the drum without damaging any of the lifting equipment. Between the load and the termination of the elongated member to the drum, the elongated member will have a number of safety/tensioning turns. The minimum breaking load of the connecting device should be equal to or greater than the minimum breaking load of the elongated member, taking into account the tensioning through safety turns, as will be understood by a person skilled in the art.

In a second aspect the disclosure relates to a method for connecting first and second elongated members by means of a connecting device according to claim 1 of the present application, wherein the method comprises the steps of: reducing the diameter of an end part of the first elongated member, reducing the diameter of an end part of the second elongated member, fastening the first and second connecting members to the reduced diameter portions of the first and second elongated members, respectively, and connecting the first and second elongated members by connecting the first and second connecting members to a link member.

The connecting device may, as described above, constitute a weak link. In that case, the breaking load of the remaining part of the elongated members in the reduced diameter portions should be higher than that of the connecting device. Alternatively, the weakest part of the total assembly of the connecting device and the reduced diameter portion of the elongated member may be used to predict the required number of safety turns on the drum.

In one embodiment the method may further comprise the step of fastening the first and second elongated members to their respective first and second connecting members at least partially by means of a resin adhesive, such as epoxy. A person skilled in the art will know how the end of an elongated member, such as steel rope, can be thinned down, broomed, and socketed by means of a resin, such as epoxy.

In one embodiment the method may comprise the step of pulling the connected first and second elongated members onto a drum. Further the method may comprise the step of spooling/pulling a first layer of elongated member onto the drum with a tension of less than a safe working load of the elongated members and/or of the connecting device, i.e. with a tensions lower than the weakest link in the total assembly of the connecting device and the elongated members. This may be beneficial for relieving the drum for forces/hoop stresses in excess of its capacity. In yet another embodiment the method may comprise the step of spooling/pulling the elongated member onto the drum with a force not exceeding 10% of the safe working load of the elongated members and/or connecting device.

In one embodiment the method may comprise the step of providing the connecting device, when connecting the first and second elongated members, at an end of a first layer of elongated member on the drum. This implies that the first elongated member, which in this case will be added to an existing second elongated member, will be laid as a first, loose layer on the drum, whereas the second elongated member will be laid on top of the first elongated member. The first turns, of the second layer will thus be the safety/tensioning turns. These first turns will not be fully loaded, and minor imperfections/damages to the connecting end of the second elongated member can be accepted. The number of safety turns will depend on the application for which the elongated members are used, but in practical, non-limiting, examples the number of safety turns may be five or six.

### BRIEF DESCRIPTION OF THE DRAWINGS

In what follows a preferred, non-liming embodiment of the disclosure is depicted on accompanying drawing, where:

FIG. 1 shows in a side view a drum with two elongated members connected by a connecting device according to the present disclosure;

FIGS. 2A-2C shows in an enlarged side view, top view and cross-section, respectively, the connecting device of FIG. 1;

FIG. 3 shows as seen through the line III-III from FIG. 1 the first and second elongated members and a connecting device according to the disclosure;

FIG. 4 shows in a side view a drum with two elongated members connected by a connecting device according to the present disclosure;

FIG. 5A-5C shows in an enlarged side view, top view and cross-section, respectively, the connecting device of FIG. 4;

FIG. 6A-6D shows in various views details of a connecting member and a bolt as comprised in a connecting device according to the present disclosure;

FIG. 7A-7C shows in various views details of a link member as comprised in a connecting device according to the present disclosure, and

FIG. 8 shows a drum in a perspective view.

### DETAILED DESCRIPTION OF THE DISCLOSURE

In the following the reference numeral 1 indicates a connecting device according to the present disclosure. The figures are shown schematically and simplified, and identical reference numerals indicate identical or similar features.

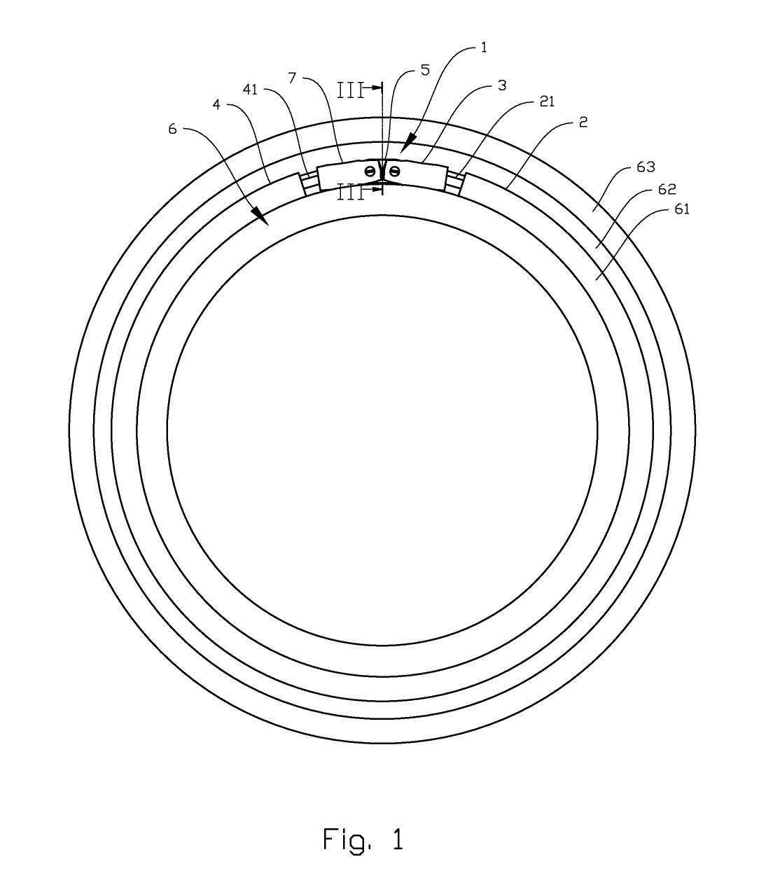

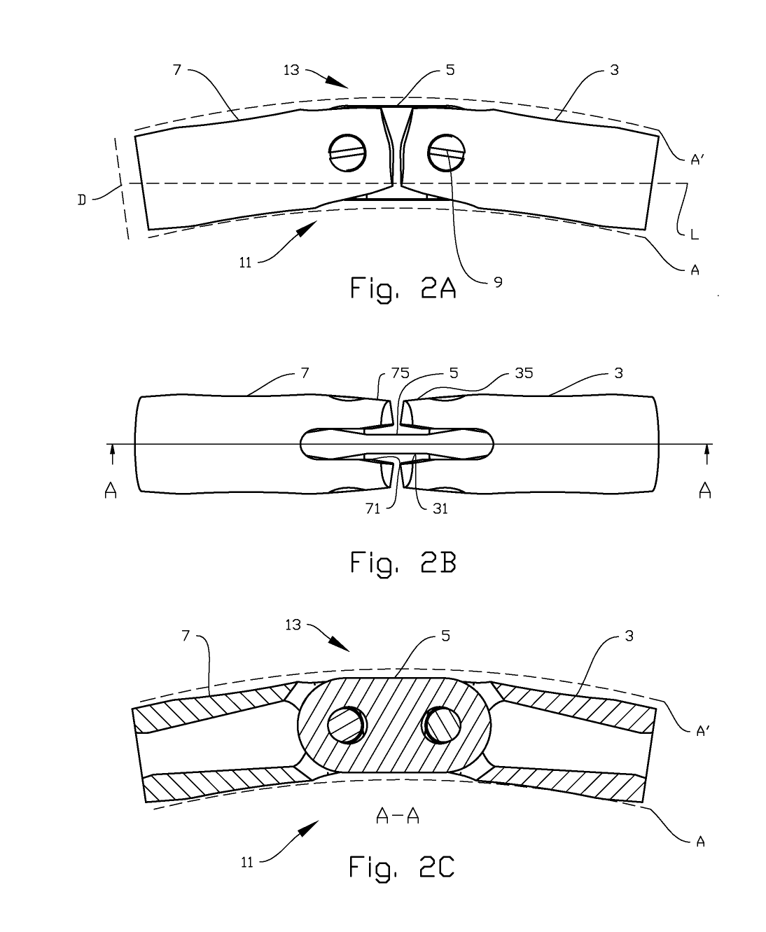

FIG. 1 shows a drum 6 on which a first elongated member 2 is stored and connected to a second elongated member 4 by means of a connecting device 1 according to the present disclosure. In the shown embodiment the elongated members 2, 4 are steel wires. The drum 6 is shown without an end flange for the sake of clarity. An inner, first layer 61 on the drum 6 includes an end of the first elongated 2 member and the start of the second elongated member 4. The start of a second layer 62 defines a first safety turn/tensioning turn on the drum 6. The end of the first elongated member 2 is formed with a reduced diameter portion 21 fastened to a first connecting member 3 of the connecting device 1. The starting end of the second elongated member 4 is similarly formed with a reduced diameter portion 41 and fastened to a second connecting member 7. The connecting members 3, 7 are fastened to the elongated members 2, 4 by means of a not shown resin adhesive. The connecting device 1 will be more thoroughly described with reference to the FIGS. 2, 5, 6, and 7 below.

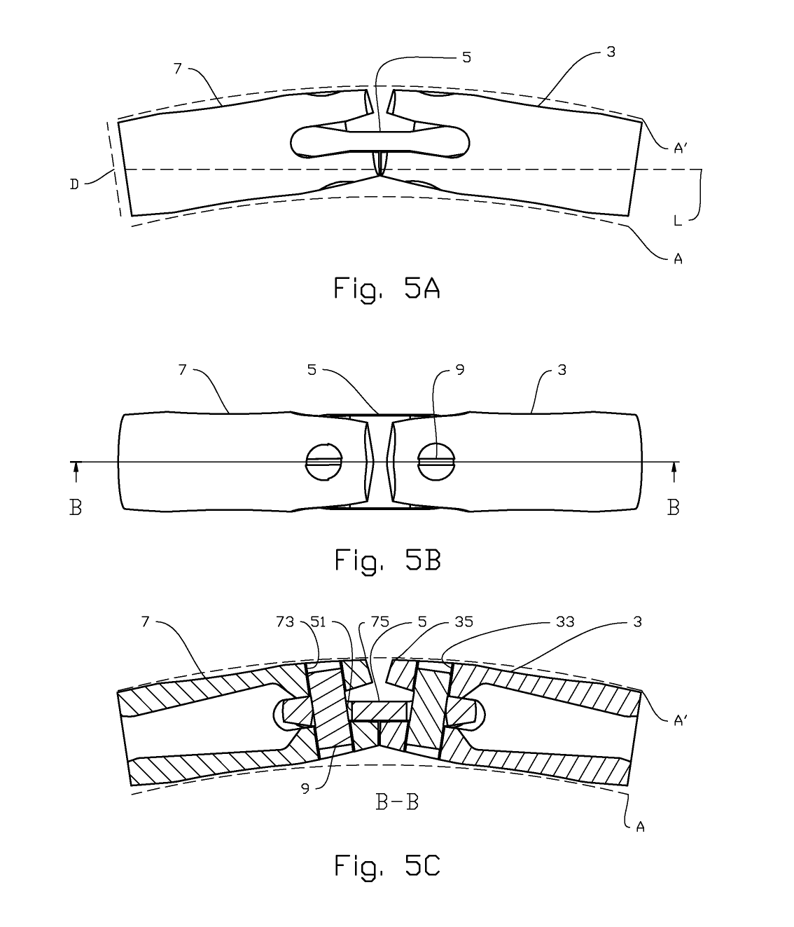

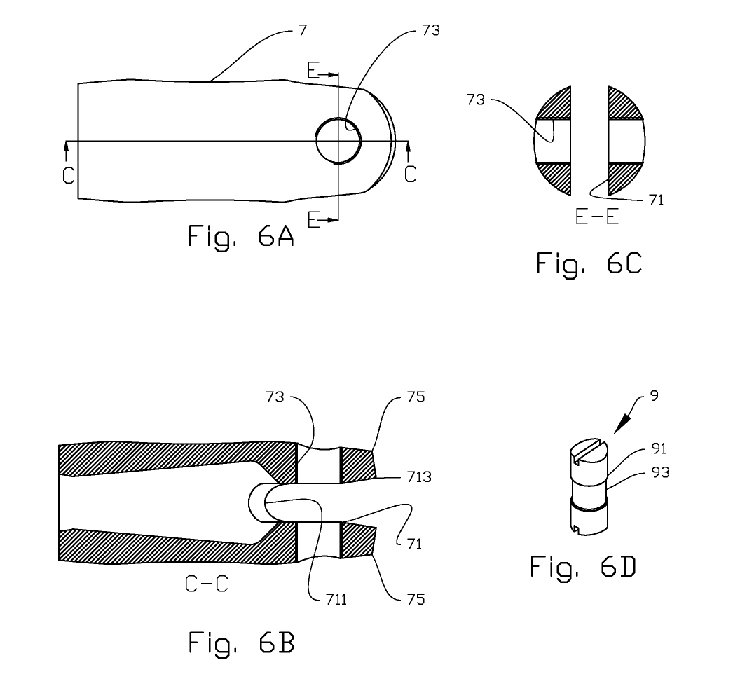

As can be best seen in FIGS. 2A-2C, the connecting device 1 is bent relative to a longitudinal axis L of the connecting device 1, so that a first part 11 of the outer surface of the connecting device 1 forms a circular arc A and a second part 13 of the outer surface of the connecting device 1 forms a circular arc A′. The first, inner part 11 of the outer surface is shaped so as to follow the curvature of the drum 6, while the second, outer part 13 of the outer surface has a curvature fitting complementary to an inner curvature of the second layer 62 of the elongated member 4 so as to support the second layer 62 of the elongated members 2 and 4 on the drum 6. The connecting device 1 in FIGS. 2A-2C is shown without being fastened to the elongated members 2, 4. In FIG. 2A the connecting device 1 is shown from the side as in FIG. 1. The connecting device 1 is formed with a maximum diameter D substantially equal to the diameter of the elongated members. The connecting members 3, 7 are connected by a link member 5 by means of bolts 9 through-going in holes 51 in the link member 5 and holes 33, 73 through-going in the connecting members 3, 7, see FIGS. 5C and 6A-6C. The connecting members 3, 7 are pivoted around the bolts 9 through-going in the link member 5 so that the whole connecting device 1 is bent. The connecting device 1 is bent so as to follow the above-mentioned circular arcs A, A′. The forming of the arcs A, A′ is also aided by the shape of the outer surface of the connecting members 3, 7, which may be partially curved. As can be seen in FIG. 2B and also in FIG. 6B, distal ends of the connecting members 3, 7 are shaped as two-tine forks with the link member 5 extending into recesses 31, 71 between the tines 35, 75 of the forks. The bolts 9 are also through-going in tapped holes 33, 73 in the tines 35, 75 of the fork-shaped distal ends of the connecting members 3, 7, see for instance FIG. 5C. FIG. 2C shows a cross section seen through the line A-A from FIG. 2B. The connecting members 3, 7 are hollow/recessed so as to be able to receive an elongated member 3, 7 therein from an end opposite of the tines 35, 75.

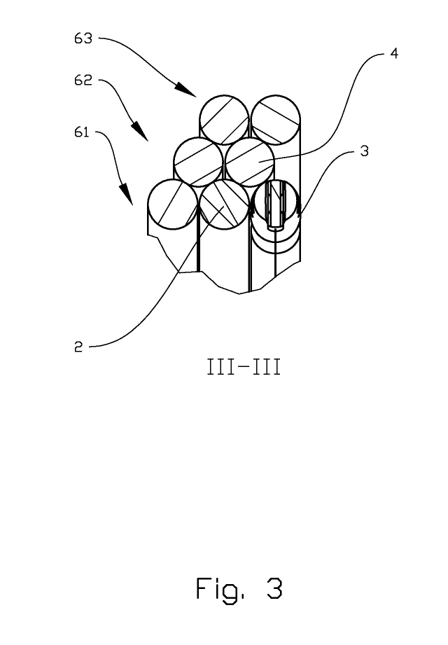

FIG. 3 shows a cross section as seen through the line III-III of FIG. 1. The figure shows three layers 61, 62, 63 of the connected elongated members 2, 4 as provided on the drum 6, where the latter is not shown in this figure. The rightmost cross-sectioned elongated member 2 of the first layer 61 defines the end of the first elongated member 2 which is connected to the first connecting member 3, whereas the adjacent cross-sectioned elongated member 4 on the second layer 62 defines the start of the first safety turn/tensioning turn. After the safety turns the elongated member 4 may be fully tensioned up to the minimum breaking load (MBL) thereof. As was described in the general part of the description, the first layer 61 may be pulled onto the drum 6 loosely/with a low tension to shield the drum 6.

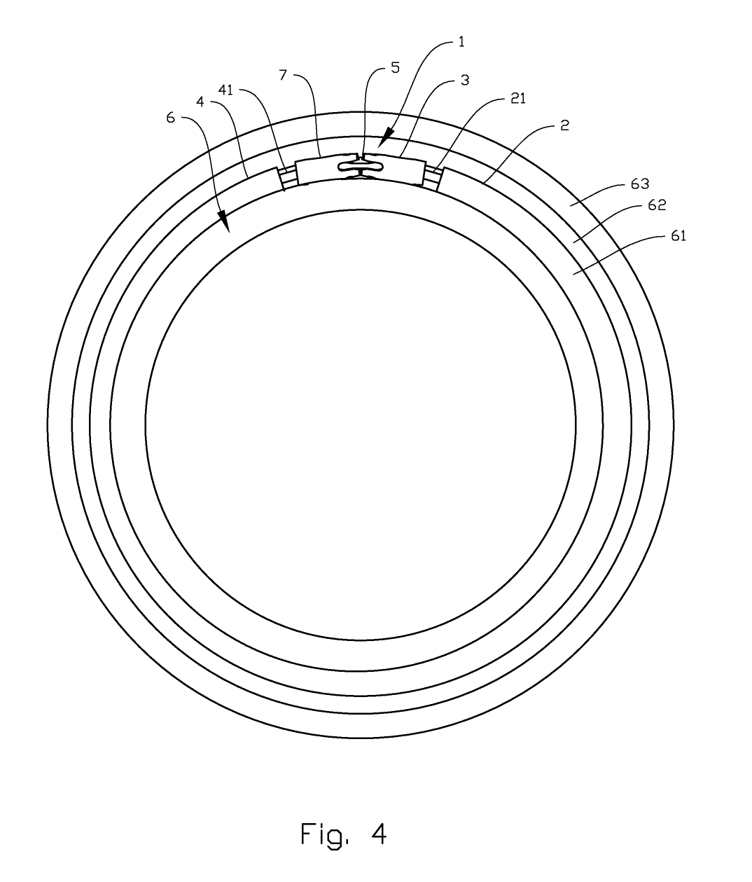

In FIG. 4 a side view of a drum 6 with elongated members 2, 4 similar to FIG. 1 is shown. A difference is that the elongated members 2, 4 and thus the connecting device 1 have been twisted 90° around the longitudinal axis of the connecting device 1. Still, the connecting device is bent, together with the elongated members 2, 4, shaped into a circular arc similar to what was described above.

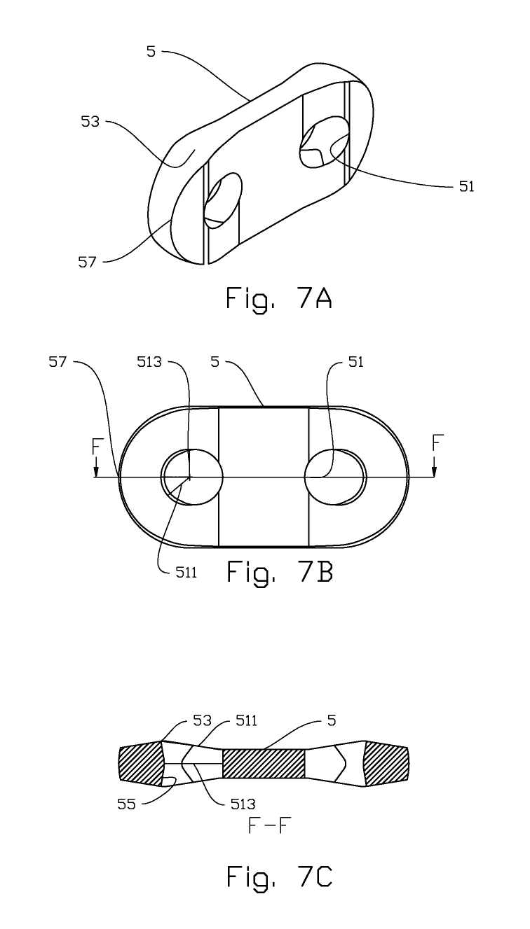

Details of the twisted connecting device 1 are shown in FIGS. 5A-5C. In this case the connection members 3, 7 and the bolts 9 have been tilted relative to the link member 5. The bolts 9, which have threaded outer parts 91, are screwed into the tapped holes 33, 73 in the tines 35, 75 of the fork-shaped connection members 3, 7. However, the bolts 9 have some play/radial clearance in the link member 5 as will be described below with reference to FIG. 7. FIG. 5C is a cross section as seen through the line B-B of FIG. 5, and it clearly shows how the bolts 9 are tilted in the holes 51 of the link member 5 so as to allow bending of the connecting device 1 also when the connecting device 1 is twisted around its longitudinal axis L.

Details of one of the connecting members 7 are shown in FIGS. 6A-6C. FIG. 6A shows the connecting member 7 as seen from the side, but not connected to an elongated member 4. FIG. 6B is a cross section as seen through the line C-C of FIG. 6A. The tapped holes 73 in the tines 75 can be seen in the figure as well as the recess 71 between the tines 75. The recess 71 has a slightly rounded inner part 711, fitting complementary to a rounded end part 57 of the link member 5, allowing the connecting member 7 to be pivoted around the bolt 9 relative to the link member 5. Further the recess 71 is formed with an outer part 713 with an enlarged width compared to the inner part 711, defining an allowable tilting angle of the connecting member 7 and the bolt 9 to be tilted relative to the link member 5. FIG. 6C shows a cross section as seen through the line E-E of FIG. 6A. FIG. 6D shows an embodiment of a bolt 9 as used for connecting the connecting members 3, 7 through the link member 5. The bolt is formed with threaded end parts 91 (threads not shown in the figure) of a first diameter and a non-threaded mid part 93 of a second, smaller diameter. In use the threaded end parts 93 will be screwed into the holes 33, 73 of tines 35, 75 of the connecting members 3, 7 while the mid part 91 will extend through the hole 51 in the link member. The heads of the bolt 9 are shaped so as to flush with the outer surface of the connecting members 3, 7.

FIGS. 7A-7C shows the link member 5 in more detail. FIG. 7A shows the link member 5 in a perspective view, while FIG. 7B shows the link member as seen from the side. FIG. 7C is a cross section as seen through the line F-F in FIG. 7B. The holes 51 of the link member are formed with a first, wide part with diameter 511 slanted inwards into the hole towards a second part with a smaller diameter 513. The hole 51 is shaped so as to allow the bolt 9 to pass through the hole 51. The shape of the hole 51 further allows the smaller diameter part 93 of the bolt 9 to be tilted in the hole 51, while maintaining contact with an outer curved edge 55 in the hole 51 of the link member 5. This implies that the connecting members 3, 7, in which the bolt 9 is firmly screwed, may be tilted relative to the link member 5 as described above and shown in the figures. The connecting device 1 is thereby adapted to follow the curvature of the elongated members 2, 4 to pass through sheaves and capstans of various diameters and to be stored on drums 6 while supporting an overlying layer of elongated member 4, even when the elongated members are randomly twisted. In practical applications, depending of the twisting around the longitudinal axis L, the bending of the connecting device 1 may be a combination between the pivoting of the connecting members 3, 7 around the bolts 9 and the tilting of the connecting members 3, 7 and the bolts 9 relative to the link member 5.

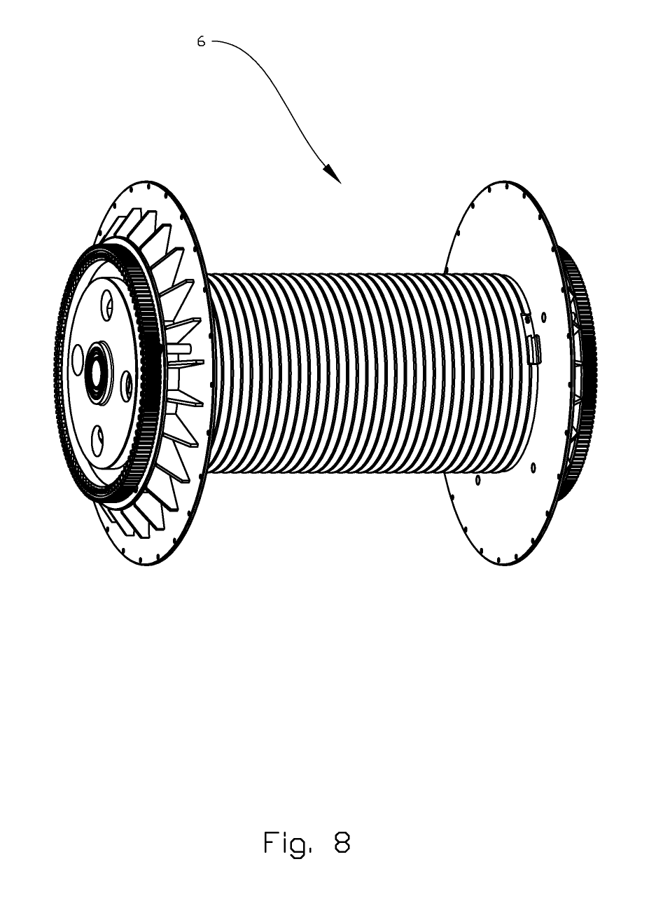

FIG. 8 shows a recessed drum 6 according to prior art on which the connected elongated members 2, 4 are adapted to be stored.

1. A connecting device for connecting first and second elongated members, the connecting device comprising:
a first connecting member configured to be connected to the first elongated member at a reduced diameter portion (21) at an end thereof;
a second connecting member configured to be connected to the second elongated member at a reduced diameter portion (41) at an end thereof; and
a link member for connecting the first and second connecting members together, wherein the first and second connecting members are hollow so as to be able to receive the reduced diameter portion of the elongated members therein, whereby the connecting device is formed with a maximum diameter substantially equal to the diameter of the first and second elongated members;
wherein the first and second connecting members are formed with a slightly curved outer surface to substantially fit a curved outer surface of the drum and support an overlying layer of elongated members.

2. (canceled)

3. (canceled)

4. The connecting device of claim 1, wherein a first part of an outer surface of the connecting device forms a substantially circular arc when the connecting device is being bent.

5. The connecting device of claim 4, wherein a second part of the outer surface of the connecting device, when the connecting device is being bent, forms a substantially circular arc.

6. The connecting device of claim 1, wherein the link member connects the first and second connecting members by a first bolt and a second bolt through-going in the connecting members and in the first and second holes in the link member.

7. The connecting device of claim 6, wherein the first and second holes of the link member are provided with a first part formed with a first diameter, and a second part formed with a second diameter.

8. The connecting device of claim 6, wherein the link member is formed with expanded width portions parallel to the center axes of the holes.

9. The connecting device of claim 1, wherein the connecting device is configured to constitute a weak link when connecting the first and second elongated members.

10. The connecting device of claim 1, further comprising a lifting crane comprising an elongated member extended by the connecting device.

11. A method for connecting first and second elongated members of a connecting device, the method comprising the steps of:
reducing the diameter of an end part of the first elongated member;
reducing the diameter of an end part of the second elongated member;
fastening the first and second connecting members to the reduced diameter portions of the first and second elongated members, respectively, and
connecting the first and second elongated members by connecting the first and second connecting members to a link member; forming the connecting members with a slightly curved outer surface, so as to aid in supporting an overlying layer and to improve the fit to a drum.

12. The method of claim 11, wherein the method further comprises fastening the first and second elongated members to their respective first and second connecting members at least partially by a resin adhesive.

13. The method of claim 11, wherein the method further comprises pulling the connected first and second elongated members onto a drum.

14. The method of claim 13, wherein the method further comprises pulling a first layer of elongated member onto the drum with a tension of less than a safe working load of the elongated members and/or of the connecting device.

15. The method of claim 14, wherein the method comprises pulling a first layer of elongated member onto the drum with a tension of less than 10% of the safe working load of the elongated members and/or of the connecting device.

16. The method of claim 13, wherein the method further comprises providing the connecting device connecting the first and second elongated members at the end of the first layer of elongate member on the drum.

17. A connecting device for connecting first and second elongated members, comprising:
a first connecting member coupled to the first elongated member;
a second connecting member coupled to the second elongated member; and
a link member having a curved outer surface and configured to couple together the first and second connecting members.

18. The connecting device of claim 17, wherein the first elongated member comprises a reduced diameter portion at an end thereof and the second elongated member comprises a reduced diameter portion at an end thereof.

19. The connecting device of claim 18, wherein the first and second connecting members are hollow so as to be able to receive the reduced diameter portion of the first and second elongated members therein, whereby the connecting device is formed with a maximum diameter substantially equal to the diameter of the first and second elongated members.

20. The connecting device of claim 17, wherein the first and second connecting members are each curved relative to a longitudinal axis of the connecting device.

21. The connecting device of claim 17, wherein the connecting device has an outer surface having a first part that forms a first circular arc.

22. The connecting device of claim 17, wherein the connecting device has an outer surface having a second part that forms a second circular arc having a different curvature than the first circular arc.
